(19) United States
(12) Patent Application Publication
(10) Pub. No.: US 2003/0174819 A1
(43) Pub. Date: Sep. 18, 2003

(54) Method for providing information service by using a network-connection device and architecture thereof

(76) Inventors: Chien-Chung Su, Taipei (TW); Fang-Te Chen, Taipei Hsien (TW); Yah-Chung Lin, Shu-Lin City (TW)

Correspondence Address: SUPREME PATENT SERVICES, POST OFFICE BOX 2339, SARATOGA, CA, 95070, US

(21) Appl. No.: 10/100,428

(22) Filed: Mar. 18, 2002

(51) Int. Cl. H04M 11/00

(52) U.S. Cl. 379/90.01; 379/93.02

(57) ABSTRACT

A network-connection device applicable between a voice communication device and a first server enables a user to enjoy the information service of the first server through the voice communication device. The network-connection device mainly comprises a connection unit, a transmission unit, a conversion unit, an output unit, and a power supply. By connecting the network-connection device coupled to the voice communication device with a communication network, a subscriber might enjoy information service of a first server through the voice communication device. A method for the first server to provide information service comprises a procedure for network connection; a procedure for identification; and a procedure for server login. After completion of above procedures, the server will provide information service upon receipt of a subscriber's requests.

### FIELD OF THE INVENTION

This invention relates generally to a connection device for communication, particularly to a network-connection device applicable between a voice communication device and a server for connecting with a communication network to enable a user to enjoy the information service provided by a server via the voice communication device.

### BACKGROUND OF THE INVENTION

The global system for mobile communications (GSM) applicable at 900 MHz, 1800 MHz, or 1900 MHz is considered the mainstream system of digital mobile communications.

A mobile phone under the assistance of WAP (wireless application protocol) or GPRS (general packet radio service) is enabled to fetch or transmit data however is entailed relatively more expense and longer time when transmitting data in a large scale, such as a graphic file or a game file, in addition to lack of the security function of personal identification. Besides, the cable phone device of the central office lines cannot directly connect to a communication network by themselves.

Therefore, this invention is proposed to connect with a communication network directly via a voice communication device and transmit mainly a text file or a simple graphic file in high security with reliable function of personal identification in a shorter time.

### SUMMARY OF THE INVENTION

The primary object of this invention is to provide a network-connection device for enjoyment of information service just through a generic voice communication device.

Another object of this invention is to provide a method for rendering information service through a voice communication device for connecting a communication network.

In order to realize the foregoing objects, a network-connection device of this invention is applicable between a voice communication device and a first server such that a subscriber might enjoy the information service of the first server. The network-connection device mainly comprises a connection unit, a transmission unit, a conversion unit, an output unit, and a power supply. A user might use the network-connection device, which is coupled with the voice communication device, to perform network connection for enjoyment of information service provided by the first server. The method shall include a step for building network connection, a step for identification, and a step for server login. After the steps are completed, the first server will provide information service according to the user's requests.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 shows the application configuration of a network-connection device of this invention;

FIG. 2 is a block diagram showing the architecture of the network-connection device of this invention;

FIG. 3 shows the operation flowchart of the network-connection device of this invention;

FIG. 4 shows the execution details of the step for building the procedures of network connection shown in FIG. 3;

FIG. 5 shows the execution details of the step for the procedures of identification;

FIG. 6 shows an application example of the network-connection device of this invention;

FIG. 7 shows an operation flowchart of the embodiment shown in FIG. 6; and

FIG. 8 shows the circuit diagram of the embodiment shown in FIG. 6.

### DETAILED DESCRIPTION OF THE INVENTION

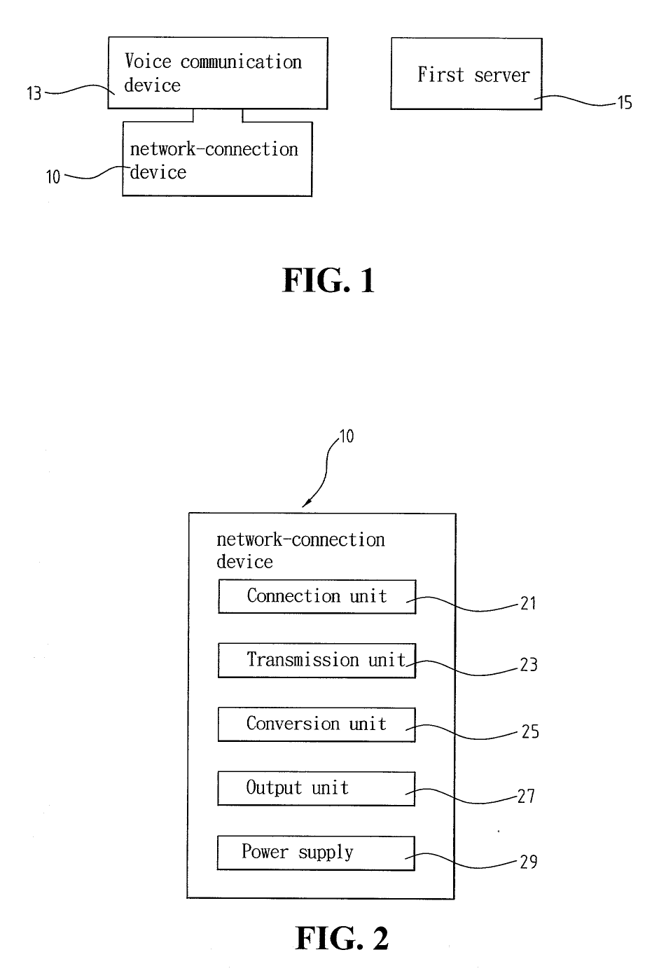

As illustrated in the application configuration shown in FIG. 1, a network-connection device 10 is connected with a network via a voice communication device 13 to enable a user to enjoy information service provided by a first server 15, in which the voice communication device 13 could be a cable phone or a mobile phone.

In the case the voice communication device 13 is a mobile phone, the global system for mobile communications (GSM) might be adopted, and the voice communication device 13 is to be connected with a connection unit 21 of the network-connection device 10 through a plugging hole in an earphone of the mobile phone. Moreover, the first server 15 might further combine with a second server for providing information service to the users.

FIG. 2 is a block diagram showing the architecture of the network-connection device of this invention. As FIG. 2 indicates, the network-connection device 10 comprises five main units, namely: the connection unit 21 for connecting the network-connection device 10 with the voice communication device 13; a transmission unit 23 for transmitting converted data of sound frequencies to the voice communication device 13; a conversion unit 25 for performing conversion between digital data and sound data; an output unit 27 for display of the converted digital data; and a power supply 29 for providing battery's dc power to the network-connection device 10.

The output unit 27 could be a liquid crystal display (LCD), and the conversion unit 25 might perform signal conversion between the sound and the digital signals in the frequency shift keying (FSK) mode. Also, the network-connection device might further contain several keys for a user to select input data or confirmation.

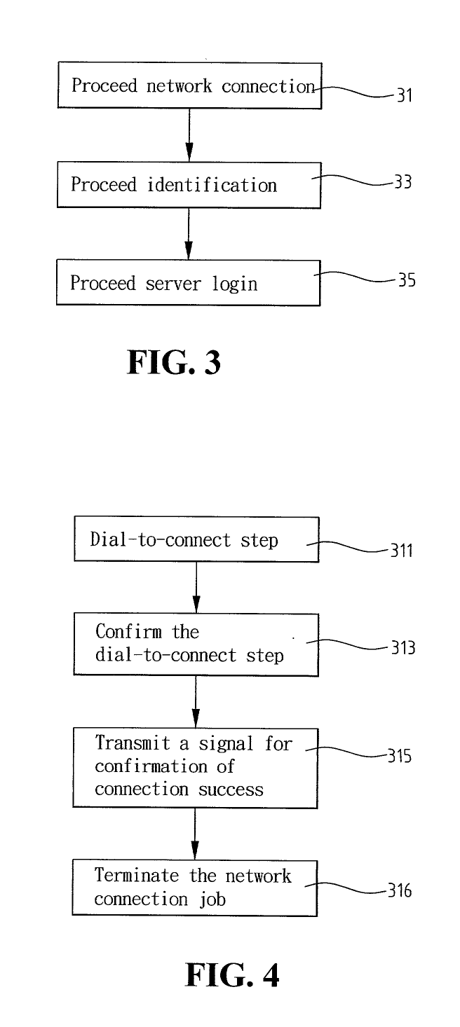

FIG. 3 shows the operation flowchart of the network-connection device of this invention. As indicated in FIG. 3, a method for the network-connection device 10 to connect with a network via the voice communication device 13 for a user to fetch data or enjoy service from a first server comprises: a procedure 31 for network connection, a procedure 33 for identification, and a procedure 35 for server login. In the procedure 35, the server login is to be done for the first server such that the same server will provide information service to a user upon receipt of his requests.

The procedure 31 for network connection further contains several steps shown in FIG. 4, including a dial-to-connect step 311 for the voice communication device 13 to connect with the first server by dialing a set of predetermined phone numbers; a confirmation step 313 for the first server to confirm the dialed numbers, and in the case of failure in confirmation, go to a step 316 for terminating the network connection job, otherwise, proceed a step 315 for transmitting a signal to the voice communication device at a subscriber end to confirm a successful connection.

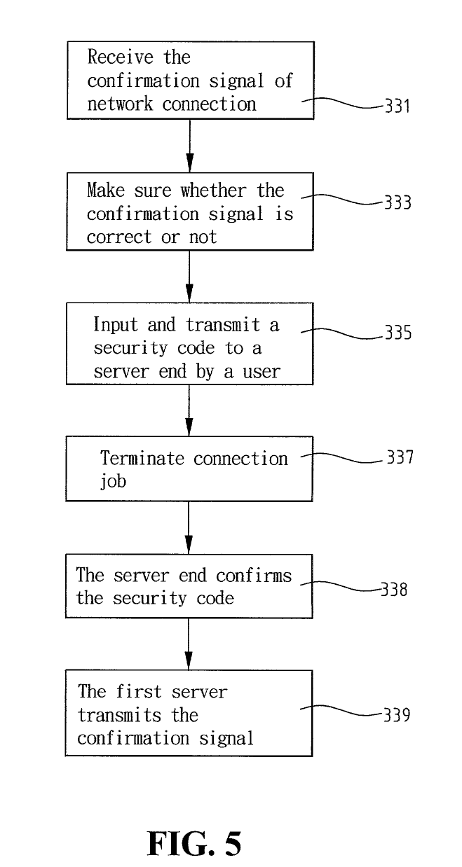

The procedure 33 shown in FIG. 3 for identification further comprises several steps shown in FIG. 5, including a step 331 for the voice communication device to receive a confirmation signal from the first server that confirms a success of network connection; a step 333 for the voice communication device to make sure whether the network connection signal is correct or not, if positive, this step is then supposed to proceed a step 335, or a connection-terminating step 337 otherwise.

The step 335 is arranged for input of a security code by a user and for transmitting the security code to a server by the voice communication device. A step 338 is to check whether the security code is correct or not by the server, that is, the first server is supposed to receive the security code and compare it with a security code of the user already deposited in that server in advance. A step 339 is to transmit a confirmation signal from the first server to the voice communication device.

The foregoing voice communication device could be the cable-phone device of the central office lines or a mobile phone. A mobile phone applicable in the global system for mobile communications (GSM) is given for illustrating this invention below.

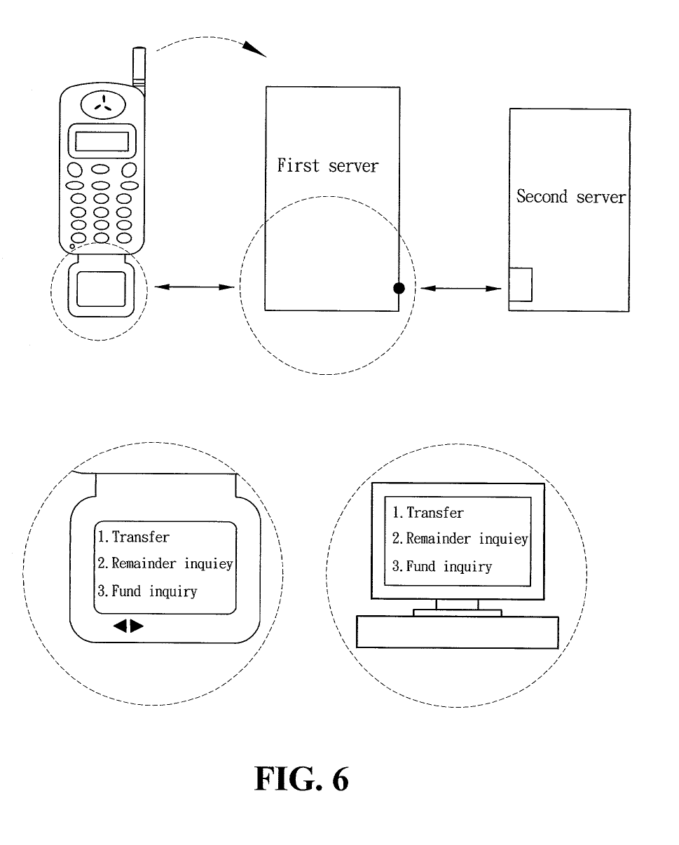

FIG. 6 is a schematic view showing an embodiment of this invention. In this embodiment, a network-connection device of this invention is operated with an associated mobile phone, which is to be dialed out a set of predetermined numbers for connecting to the first server. The first server itself can provide information service independently to some extent or it might link a second server and use the database thereof for information service, in which the first server could be provided by a system maker while the second server could be provided by a financial service company (a bank for example).

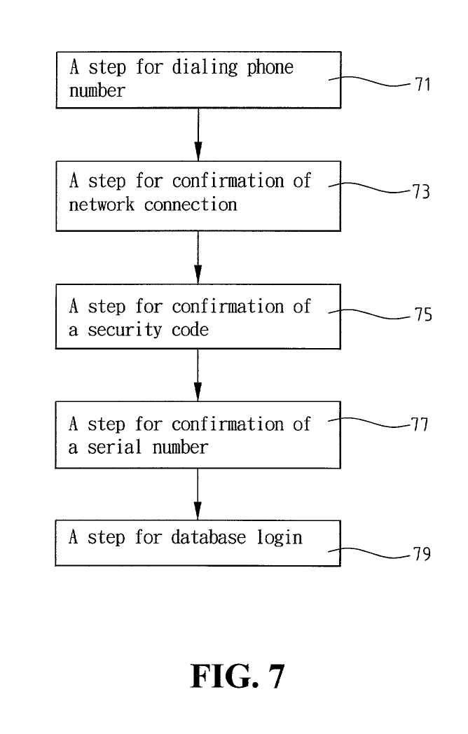

FIG. 7 is an operation flowchart of the embodiment shown in FIG. 6.

A first step is to build the procedures for network connection, in which a step 71 is the step for a user to combine the network-connection device with a mobile phone by connecting the network-connection device to an earphone plugging hole of the mobile phone, then enable the power of the mobile phone and dial out a set of specified phone numbers; and a step 73 is the step for the first server to make sure whether the dialed phone number is correct or not, if positive, transfer a network-connection confirmation signal back to the mobile phone, or terminate the network connecting action otherwise.

A second step is to proceed the procedures for identification, in which a step 75 is a security code confirmation step. Upon receipt of the network-connection success confirmation signal sent from the first server, the user should make sure by comparison whether that confirmation signal is correct or not, if positive, then transfer a security code back to the first server through his mobile phone. Similarly, the first server should also make sure whether the security code sent from the user is correct or not, if positive, then transfer back a confirmation signal, or request the user to repeat input of the security code once more or terminate the network connection directly otherwise. The security code might be a set of numbers preset in a user's mobile phone or inputted by a user on the spot, and moreover, the times allowed for redundant check of the security code is usually predetermined on site by a system maker.

A final step is to proceed the procedures for database login, in which a step 77 is the step for confirmation of a serial number. After a positive confirmation signal of the security code from the first server is received, the user has to check whether the confirmation signal is correct or not, if positive, then transfer back a serial number and data to the first server. A step 79 is the step for proceeding database login procedures. When the first server receives the serial number and data, it should make sure whether they are correct or not, if positive, then permit the user to login, or terminate the network connection otherwise.

After login is made, the user is allowed to enjoy the information service of the first server via the network-connection device and his mobile phone. Besides, the first server might link with a second server so that a user is permitted to inquire or use the data in the second server indirectly through the first server.

In the foregoing embodiment, the second server is prepared by a bank for providing financial service to its clients via the first server, such as inquiry for remainder, transaction, and credit card, or financial service for transfer or code alteration, etc., depending on service contents of different banks.

A set of push buttons is arranged on the network-connection device for input of data. Thus, a user might use the push buttons or the keys on a mobile phone to input data.

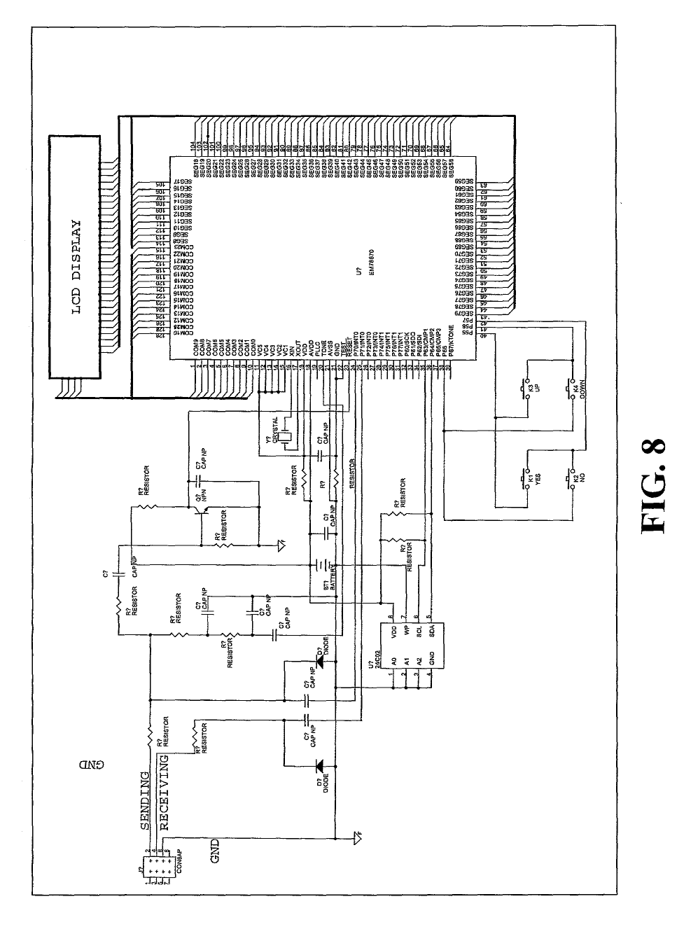

FIG. 6 is a schematic view showing the network-connection device of this invention being operated in association with a mobile phone and realized by the circuitry shown in FIG. 8.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A network-connection device, which is applicable between a voice communication device and a first server to enable a user to enjoy the information service provided by the first server through the voice communication device, comprising:
a connection unit for connecting the network-connection device with the voice communication device;
a transmission unit for transmitting the converted sound data to the voice communication device;
a conversion unit for performing conversion between digital data and sound data;
an output unit for display the converted digital data; and
a power supply for providing battery's dc power to the network-connection device.

2. The network-connection device according to claim 1, in which the voice communication device is a cable phone device of the central office lines.

3. The network-connection device according to claim 1, in which the voice communication device is a mobile phone.

4. The network-connection device according to claim 3, in which the mobile phone is applied in the global system for mobile communications (GSM).

5. The network-connection device according to claim 3, in which the mobile phone is connected with a connection unit of the network-connection device through a plugging hole in an earphone of the mobile phone.

6. The network-connection device according to claim 1, in which the first server further combines with a second server and provides the data stored therein to the subscribers.

7. The network-connection device according to claim 1, in which the output unit is a liquid crystal display (LCD).

8. The network-connection device according to claim 1, which further comprises a plurality of keys for a user to operate selection of input data or confirmation.

9. The network-connection device according to claim 1, in which the conversion unit is to perform conversion between digital data and sound data in the frequency shift keying (FSK) mode.

10. A method for providing information service, which uses a network-connection device coupled with a voice communication device to enable a subscriber to enjoy the information service provided by a first server, comprising:
proceeding a procedure for network connection;
proceeding a procedure for identification; and
proceeding a procedure for server login (the first server in this case) such that the server will provide information service upon receipt of a user's requests.

11. The method according to claim 10, in which the procedure for network connection further comprises:
a dial-to-connect step for the voice communication device to connect with the first server by dialing a set of predetermined phone numbers; and
a confirmation step for the first server to confirm the dialed numbers, and in the case of failure in confirmation, go to a step for terminating the network connection job, otherwise, proceed a step for transmitting a signal to the voice communication device at a subscriber end to confirm a successful network connection.

12. The method according to claim 10, in which the procedure for identification further comprises:
(A) A step for the voice communication device to receive a confirmation signal from the first server that confirms a success of network connection;
(B) A step for the voice communication device to make sure whether the network connection signal is correct or not, if positive, to proceed the next step (C), or a connection-terminating step (E) otherwise;
(C) A step for input of a security code by a user and for transmitting the same to a server by the voice communication device;
(D) A step for the first server to check whether the received security code is correct or not by comparing it with a security code of the user already deposited in that server in advance;
(E) A step for terminating network connection; and
(F) A step for transmitting a confirmation signal from the first server to the voice communication device.
